(19) United States
(12) Patent Application Publication
(10) Pub. No.: US 2011/0173540 A1
(43) Pub. Date: Jul. 14, 2011

(54) DYNAMIC USER INTERFACE FOR WIRELESS COMMUNICATION DEVICES

(76) Inventors: Jason BRITTON, Vista, CA (US); John Salisbury, Carlsbad, CA (US); Rhon Manlapaz, Bellevue, WA (US); Eduardo Apodaca, Santa Barbara, CA (US)

(21) Appl. No.: 12/415,928

(22) Filed: Mar. 31, 2009

Related U.S. Application Data
(60) Provisional application No. 61/041,167, filed on Mar. 31, 2008.

(51) Int. Cl. G06F 3/048

(52) U.S. Cl. 715/733

(57) ABSTRACT

A user interface for a wireless communication device has a visual interface that includes multiple visual elements representing events of the same type where non-textual visual characteristics represent unique information of the events. Accordingly, the visual interface includes at least a first visual element representing a first event occurring at a wireless communication device and a second visual element representing a second event occurring at the wireless communication device and being of the same event type as the first event. The first visual element has a first non-textual visual characteristic representing first information related to the first event and the second visual element has a second non-textual visual characteristic representing second information related to the second event different from the first information. The event type is one of a received email event, a transmitted email event, a voice mail event, a missed call event, a received text message event, a sent text message event, a dialed call event, or a received call event.

### RELATED APPLICATIONS

This application claims the benefit of priority of U.S. Provisional application No. 61/041,167 entitled “USER INTERFACE FOR MOBILE WIRELESS DEVICES”, docket number PRO 00898, filed Mar. 31, 2008 and incorporated by reference in its entirety, herein. This application is also related to U.S. application Ser. No. 12/413,482 entitled “CALCULATING ROUTE AND DISTANCE ON COMPUTERIZED MAP USING TOUCHSCREEN USER INTERFACE”, docket number UTL 00898, filed on Mar. 27, 2009 and incorporated by reference in its entirety, herein.

### FIELD

This invention generally relates to user interfaces and more particularly to a dynamic user interface for wireless communication devices.

### BACKGROUND

Wireless communication devices often have a user interface that includes a visual interface to convey information to the user. Conventional user interfaces typically include multiple pages, screens and/or menus allowing a user to navigate through stored information, functional options and other preferences. One or more screens may visual interface events that have occurred at the wireless communication device. The events may include several different event types such as emails events, voice mail events, call events, and text message events.

### SUMMARY

A user interface for a wireless communication device has a visual interface that includes multiple visual elements representing events of the same type where non-textual visual characteristics represent unique information of the events. Accordingly, the visual interface includes at least a first visual element representing a first event occurring at a wireless communication device and a second visual element representing a second event occurring at the wireless communication device and being of the same event type as the first event. The first visual element has a first non-textual visual characteristic representing first information related to the first event and the second visual element has a second non-textual visual characteristic representing second information related to the second event different from the first information. The event type is one of a received email event, a transmitted email event, a voice mail event, a missed call event, a received text message event, a sent text message event, a dialed call event, or a received call event.

### BRIEF DESCRIPTION OF THE DRAWINGS

FIG. 1 is a block diagram of a wireless communication device with a user interface visual interface.

FIG. 2 is an illustration of a table including an example of event types and information represented by non-textual visual characteristics of elements in a visual interface.

FIG. 3 is a block diagram of wireless communication device with an interactive visual interface including an environment having elements with visual characteristics dependent on input device detection (user action, sensor), events, and software generated ambient information.

FIG. 4A is an example of series of screen shots on a wireless communication device where a non-textual visual characteristic of an element is based on a detected event.

FIG. 4B is an illustration of series of screen shots on a wireless communication device where a non-textual visual characteristic of an element is based on a detected event.

FIG. 5 is an illustration of a series of screen shots presented on a wireless communication device where a non-textual visual characteristic of an element is based on a generated event.

FIG. 6 is an illustration of a series of screen shots presented on a wireless communication device where non-textual visual characteristics of elements are based on a generated event, detected events, and communication events.

FIG. 7 is a flow chart of a method of user interface management for displaying different events at a wireless communication device.

FIG. 8 is a flow chart of a method of user interface management for displaying communication events, detected events and generated events at a wireless communication device.

### DETAILED DESCRIPTION

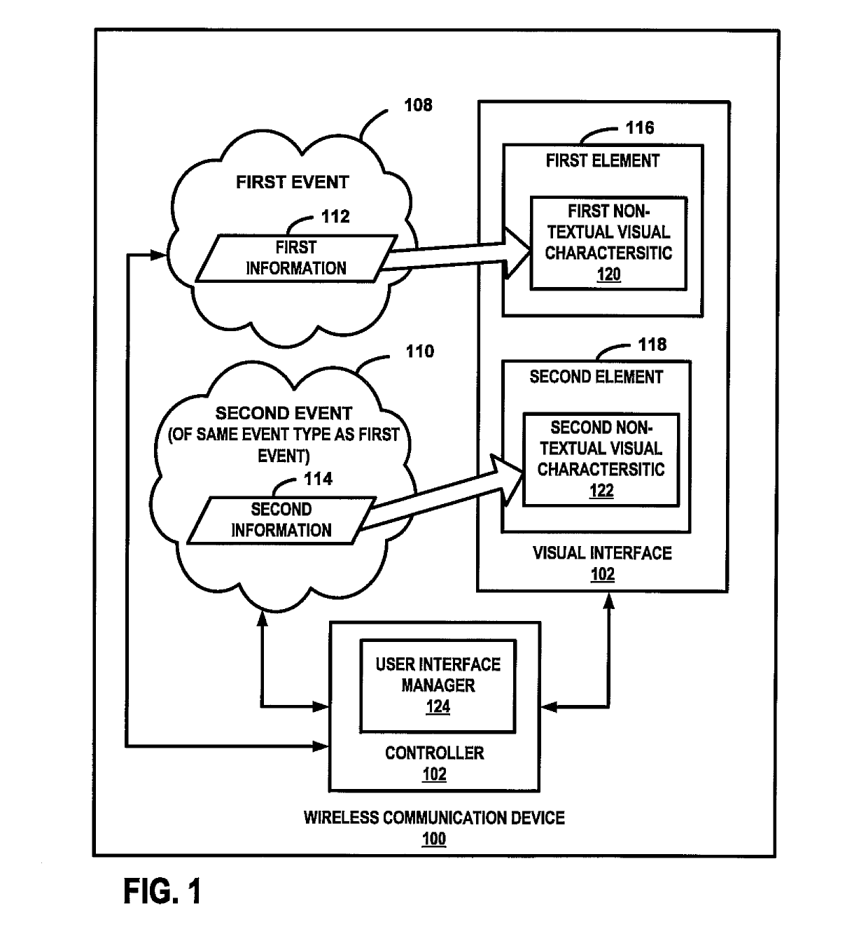

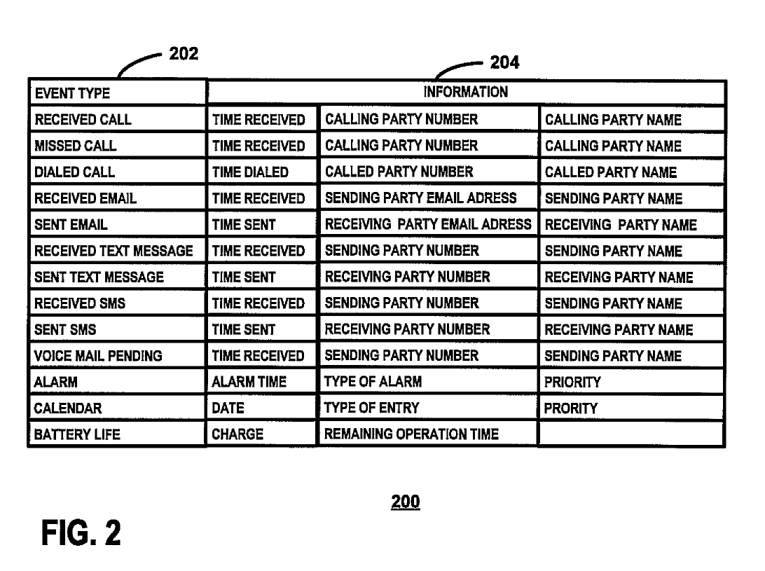

FIG. 1 is a block diagram of a wireless communication device 100 including a visual interface 102, such as visual interface, of a user interface 104. The wireless communication device 100 is capable of communicating with one or more transceiver nodes in a communication system. A controller 106 manages communication and performs the functions described herein as well as facilitating the overall operation of the wireless communication device 100. The wireless communication device 100 may support any combination of communication types such as, for example, full duplex voice communication, half duplex voice communication, email, text messaging, short message service (SMS), and/or broadcast services. The wireless communication device 100 may also provide access to features and services provided by the communication system. For example, the wireless communication device 100 may provide access to voice mail, Internet service, and downloading services such a ring tone, music, video, multimedia, and application downloading services. When in use, the wireless communication device 100 supports the occurrence of events 108, 110 related to communication services, applications, and accessible features. An event 108, 110 is an occurrence that changes a status of the wireless communication device 100 or invokes an action by the controller 106. As discussed in further detail below with reference to FIG. 2, events 108, 110 are grouped as event types where examples of event types include receipt of an email, transmission of an email, a received call, a dialed call, a missed call, a transmitted text message, a received text message, a received SMS message, a transmitted SMS message, and notification of a voicemail. An event 108, 110, therefore, is a specific unique occurrence that can be categorized into an event type.

For the example in FIG. 1, a first event 108 and a second event 110 are depicted as clouds. The first event 108 and the second event 110 are of the same event type. Applying an example, the first event 108 can be a first missed call and the second event 110 can be a second missed call. Since the two events 108, 110 are separate discrete events, at least some information 112, 114 related to each event 108, 110 is different from information 112, 114 related to the other event 108, 110. Continuing with the example, the first information 112 may be a first calling number and the second information 114 may be a second calling number where the first event 108 is a missed call from the first calling number and the second event 110 may be a missed call from a second calling number.

The visual interface 102 includes a first element 116 corresponding to the first event and 108 a second element 118 corresponding to the second event 110. The element 116, 118 is any kind of visual image, icon, picture, cartoon, or visual representation that includes at least one non-textual visual characteristic 120, 122 corresponding to information 112, 114 of the associated event 108, 110. The controller 106 processes unique information 112, 114 associated with the events 108, 110 to generate the visual elements 116, 118 that include a non-textual visual characteristic 120, 122 corresponding to the unique information 112, 114. Accordingly, the first information 112 unique to the first event 108 is represented in the first non-textual visual characteristic 120 and the second information 114 unique to the second event 110 is represented by the second non-textual visual characteristic 122. Examples non-textual visual characteristics 120, 122 include color, size, intensity, contrast, shape, transparency, motion, and positions within the visual interface. Visual characteristics 120, 122 based on motion of the element 116, 118 may include a movement path, speed of movement, acceleration of the element, deceleration of the element, and predictability of the movement (randomness of the movement). The elements 116, 118 may include some text or indicia in addition to the non-textual visual characteristic in some circumstances. Further, the visual interface 102 may include other elements where some elements may represent different event types. Also, additional elements of the same type may include the same non-textual visual characteristics as other elements. This may occur where the information represented by the non-textual visual characteristic is the same for more than one event. Further, an element may include more than one non-textual visual characteristic representing different information. The above scenarios are further discussed with the examples below after discussion of the interaction between the controller and visual interface.

The controller 106 is any processor, microprocessor, processor arrangement, computing device, logic or other electronics that are capable of running code to perform the functions described herein as well as facilitating the overall functionality of the wireless communication device 100. The controller 106 may include a memory and other hardware, software, and/or firmware for interfacing, communicating, and otherwise performing the functions.

At least some aspect of an event 108, 110 is processed, controlled, initiated, managed, invoked, monitored, and/or reacted to by the controller 106. Accordingly, the controller 106 is aware of all events. A user interface manager 124 of the controller generates the environment and elements shown on the visual interface. For the exemplary embodiments discussed herein, the user interface manager 124 is implemented by running code on a processor (such as the controller 106). Various graphics engines and processes may be invoked or implemented as part of the user interface manager 124. When an event 108, 110 occurs, the user interface manager 124 processes the corresponding information dictated by the user interface manager code and/or user settings. The element 116 is generated with the appropriate non-textual visual characteristic 120 and displayed on the visual interface 102. The generated and visually displayed environments and elements may include any of numerous depictions, movements, themes, and visual aspects. Examples of some of the situations discussed above are provided below with reference to a fish pond environment.

For the following example, the first event 108 is a missed call from a first calling number and the second event 110 is a second missed call from a second calling number. The first information 112 is the first calling number and the second information 114 is the second calling number. In the examples, the visual interface 102 depicts fish swimming in a pond where the fish represent missed calls. The first information 112 results in a fish that has a blue body and the second information 114 results in a fish that has red body. For this example, therefore, the non-textual visual characteristics 120, 122 are different colors. Accordingly, the user interface 104 provides a visual representation of a history of events where the user can easily determine at least some aspects of the events. By observing that the pond includes a blue fish and a red fish, the user can easily determine that two different callers have tried to reach the user. Where each color represents a caller that is known by the user, the fish convey the identity of the caller. For example, blue may be assigned to the phone number of a mobile device belonging to the user's spouse and red may be assigned to a device of the user's child.

In an example where the elements include more than one non-textual visual characteristic, each fish includes a transparency that corresponds to the age of the missed call. More recent missed calls are depicted as more opaque fish and older missed calls are represented by fish that are more transparent. Another example includes having older calls represented by slower moving fish. In a situation where the user's spouse called twice and the calls were missed, the visual interface may include two blue fish. Where call age is represented, the fish can be distinguished by an additional visual characteristic as speed or transparency.

In an example where other event types are represented in the visual interface, different types (species) of fish represent different event types. Star fish may represent voice mail messages, goldfish may represent text messages, and bluegills may represent email messages.

The environment depicted in the visual interface may convey a plethora of information visually to the user. A single glance at the visual interface provides information about the history and status of events that have occurred. Such a visual interface has several advantages of over conventional user interfaces. One advantage includes the ability of the user to obtain information about multiple events without navigating through menus or accessing different screens. Although conventional interfaces may provide information about different types of events, they do not provide information regarding events of the same type. For example, some conventional visual interfaces may indicate that a voice mail is pending or that there call has been missed. An icon may provide this indication in some systems. The user, however, cannot determine how many voice mails or missed calls have occurred or determine any information regarding the events other than at least one event has occurred. If additional information is desired in these conventional interfaces, the user must access a different menu or specific screen.

Another advantage of the described embodiments over conventional systems, includes improved privacy. In conventional systems, information regarding an event is often depicted with text describing the event. An eavesdropper can easily observe the information by looking at the screen without accessing the device. Where the information is conveyed with non-textual visual characteristics only known to the user of the device, however, the visual interface does not convey information to the eavesdropper. Such a situation may occur where the wireless communication device is left in a table without supervision of the user. A new event, such as an incoming text message may be indicated purely by non-textual visual characteristics. Someone seeing the new element appear on the screen could not determine any information about the event.

FIG. 2 is an illustration of a table 200 including an example of event types 202 and information 204 represented by non-textual visual characteristics of elements in a visual interface. The table 200 is only one example of the numerous combinations of event types and information that may be applied to a user interface. For the example, the event types include received calls, missed calls, dialed calls, received email messages, sent email messages, received text messages, sent text messages, received short message service (SMS) messages, sent SMS messages, voice mail pending, alarm, calendar, and battery life. Each event may have one or more information categories 204. For example, received calls and missed calls have information categories 204 of time received, calling party number, and calling party name. Information available for any event 202 may include information for any combination of the information categories 204

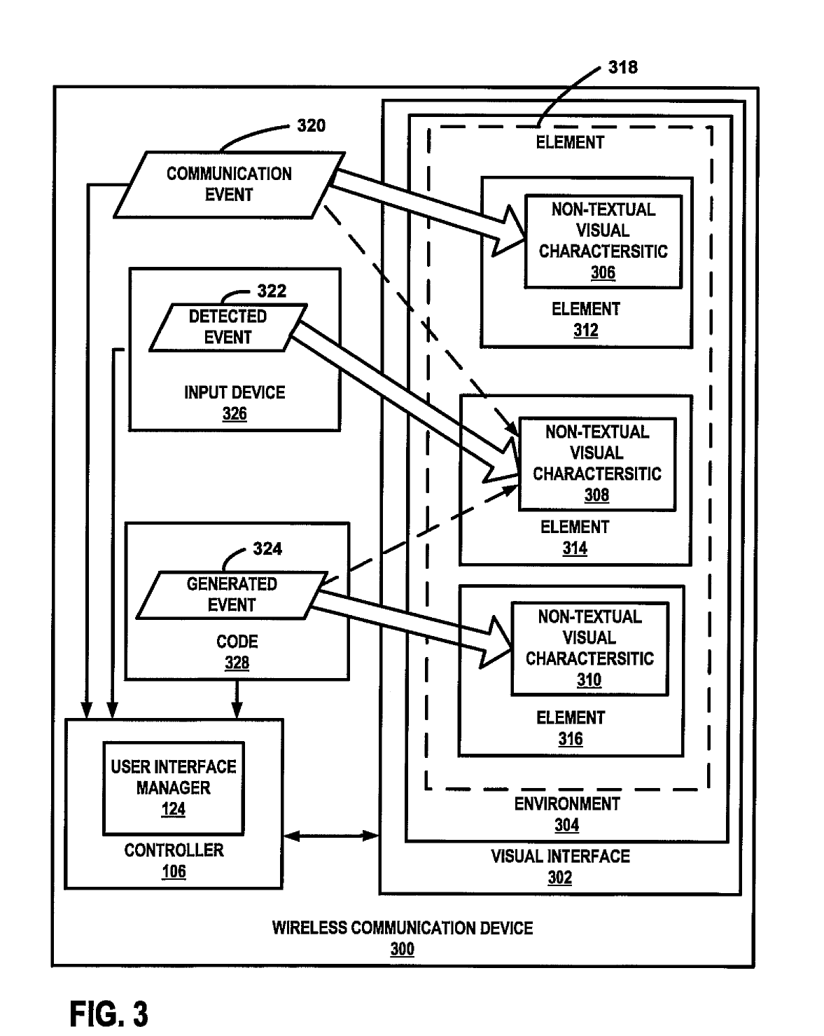

FIG. 3 is a block diagram of wireless communication device 300 with an interactive visual interface 302 including an environment 304 having elements with non-textual visual characteristics 306, 308, 310 dependent on input device detection (user action or sensor), events, and software generated ambient information. The environment 304 is a collection of visual components in the visual interface 302 where at least some of the components are related to each other and to a general theme. Examples of environments 304 include visual representations of actual and fictional geographical locations, buildings, or objects. The theme and components of an environment 304 are unlimited. The environment 304 includes elements 312, 314, 316, 318 that may be static or dynamic with respect to appearance or position within the environment 304. Each element, therefore, has at least one non-textual visual characteristic where the non-textual visual characteristic may be static (unchanging) or dynamic (potentially changing). An element may have several non-textual visual characteristics including any combination of dynamic and static characteristics. As described in further detail below, a non-textual visual characteristic may be dependent on one more events where the events may be communication events (received call, missed call, incoming call, email, etc.) a detected event (user input from keypad, movement, temperature, etc.) and/or a generated event (software generated data that is not related to an external event). A more specific example of an environment with elements includes a representation of city with buildings and roadways. Elements may include the buildings and roadways as well as vehicles, people, pets, and lighting. An element such a vehicle element may be dynamic in that it is moving down a roadway within the environment

The visual interface 302 is generated and managed by a user interface manager 124 implemented within a controller 106 such as a processor. Data related to one or more of a communication event 320, a detected event 322, and/or a generated event 324 is/are processed by the user interface manager 124 to generate an image within an environment 304 where the image includes a non-textual visual characteristic corresponding to the communication event 320, the detected event 322, the generated event 324, or a combination thereof. In FIG. 3, large block arrows represent a correspondence between an event and a non-textual visual characteristic. The dashed line arrows represent optional correspondence between the events and the non-textual visual characteristics. Each non-textual visual characteristic may be uniquely associated with and based on a single element or may be associated with and based on multiple events, where the events may of the same type or may be of different types. The blocks representing the elements 312, 314, 316 are formed with dashed lines to illustrate that some elements may include only non-textual visual characteristics related to one type of event.

A communication event 320 is any event related to the communications with the wireless communication device 300. Examples of communications include receiving and transmitting voice, data, multimedia, music, video, email, and text message information as well as transmitting and receiving control signal data. Accordingly, examples of communication events 320 include the receipt of an email, transmission of an email, a received call, a dialed call, a missed call, a transmitted text message, a received text message, a received SMS message, a transmitted SMS message, and notification of a voicemail. Since the controller 106 manages all functions related to communications, the controller 106 is aware of all communication events 320. Information related to the communication events 320 is forwarded to the user interface manager 124 within the controller 106.

A detected event 322 is any event detected by an input device 326 such as a sensor, input device, or user interface. Examples of input devices include sensors, keypads, touch visual interfaces, buttons, touch pads, keyboards, microphones, motion detectors, orientation detectors, current detectors, voltage detectors, power detectors, and position detectors such GPS devices. The visual interface 302 and the input device 326 may be same device in some circumstances. Data from the input device 326 is received by the controller 106 and forwarded to the user interface manager 124.

A generated event 324 is any event that occurs due to code 328 running on a processor that is not based on an external event such as communication event 320 or a detected event 322. The code 328 may be software or firmware and may be running on the same processor as the controller 106 or may be running on a separate computer, processor, controller, or other collection of electronics. Examples of generated events 324 include control signals for producing random or repetitive changes in an element or the visual interface environment. The changes may include changes in color, motion, size, position or any other visual characteristic that may appear random, cyclical or otherwise uncorrelated to external events. A more specific example of a generated event 324 includes generation of data for controlling the motion of a graphical fish in a graphical pond environment on the visual interface. The data may allow the fish to swim in particular pattern or to swim randomly. If based solely on a generated event 324, therefore, the path of the fish is uncorrelated to communication events and detected events. In circumstances where the visual characteristics of the element are based on a combination of events, the particular visual characteristic related to the generated event may be modified by another event. For the fish example, a swimming fish may change direction or speed when a detected event occurs although the underlying motion is based on the generated data. More specifically, one example includes the detection of user input on a touch screen performing the function of the visual interface. The user may, for example, touch the visual interface directly in front of the path of the fish and, in response, the user interface manager modifies the generated path of the fish to change direction to avoid the position of the screen touched by the user.

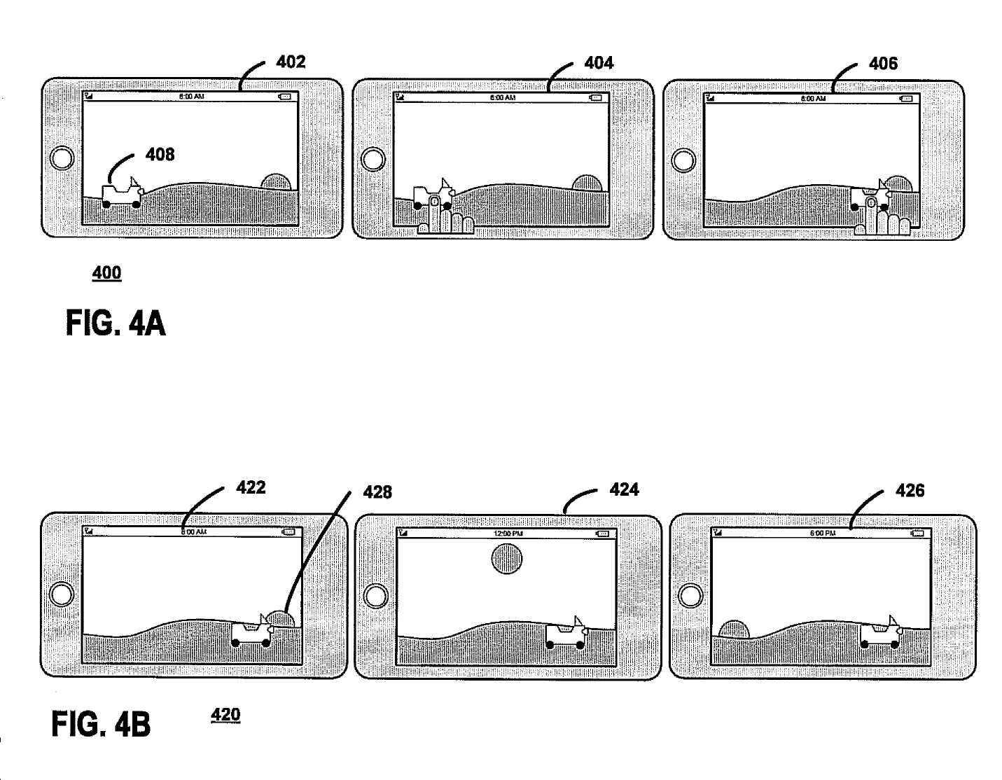

FIG. 4A is an example of series of screen shots 402, 404, 406 on a wireless communication device where a non-textual visual characteristic of an element 408 is based on a detected event. The detected event in the example is user input entered through a touch screen.

In the first screen shot 402, the element 408 has a first position. In the second screen shot 404, the element 408 is in the first position at the time user input begins. The element is in second position in the third screen shot 406. User input is complete in the third screen shot 406. Accordingly, for the example of FIG. 4A, the user input results in a change in non-textual visual characteristics of the element 408 resulting in a change in position of the element 408 within the environment.

FIG. 4B is an illustration of series of screen shots 422, 424, 426 on a wireless communication device 300 where a non-textual visual characteristic of an element 428 is based on a detected event 322. The detected event 322 in the example is the time of day.

In the first screen shot 422, the element 428 has a first position. For this example, the element 428 is a sun and the position in the first screen shot 422 represents a time in the morning. In the second screen shot 424, the element 428 is in a second position representing midday. The element 428 is in a third position in the third screen shot 426 represent evening. Accordingly, for the example of FIG. 4B, the data related to a detected event is an output from a clock. The user interface manager 124 processes the data to generate a change in non-textual visual characteristics of the element 428 resulting in a change in position of the element 428 within the environment.

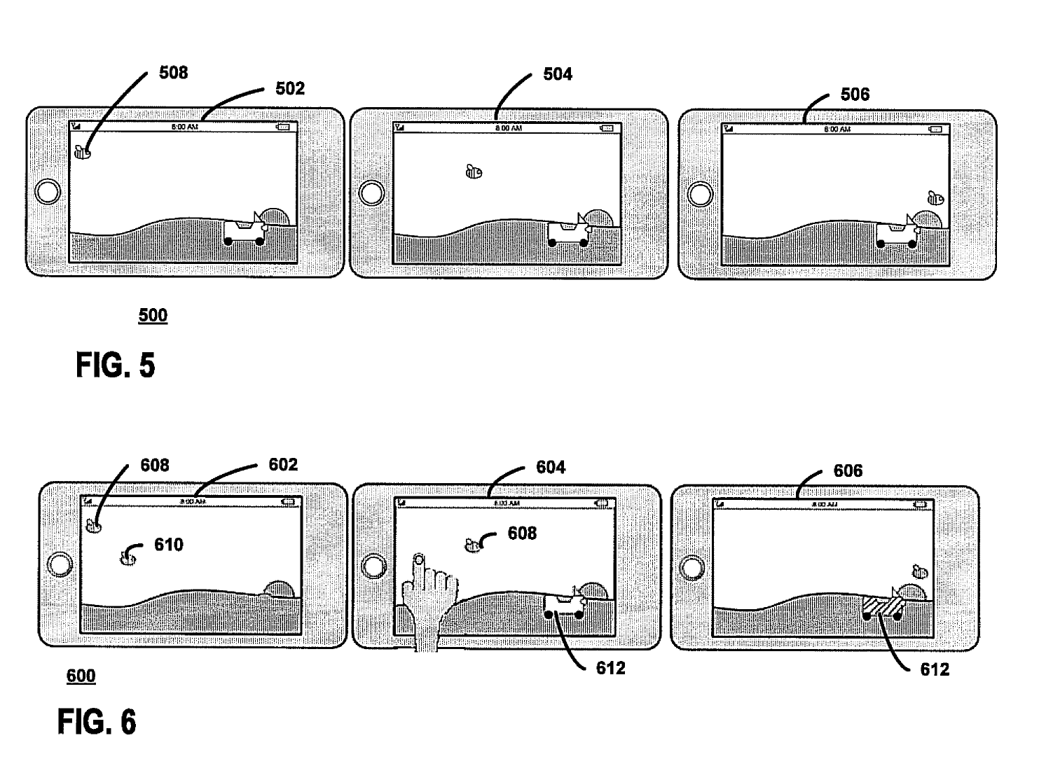

FIG. 5 is an illustration of a series of screen shots 502, 504, 506 presented on a wireless communication device where a non-textual visual characteristic of an element 508 is based on a generated event. The generated event in the example is generated data for controlling a motion of the element 528 within the environment.

In the first screen shot 502, the element 508 has a first position. For this example, the element 508 is a bird. In the second screen shot 504, the element 508 is in a second position. The element 508 is in a third position in the third screen shot 506. The position of the element 508 and the motion path through the environment is not based on any external events in this example. The user interface manager 124 processes the data to generate a change in non-textual visual characteristics of the element 508 resulting in a change in position and motion of the element 508 within the environment.

FIG. 6 is an illustration of a series of screen shots 602, 604, 606 presented on a wireless communication device where non-textual visual characteristics of elements 608, 610, 612 are based on a generated event, detected events, and communication events. The existence of the first element 608 and the second element 610 and third element 612 in the example represent the occurrence of communication events. The existence of the first element 608 and the second element 610 represent pending voice mails and the third element 612 represents an incoming voice call. The generated event in the example is generated data for controlling the motion of the first element 608 and the second element 610 within the environment.

In the first screen shot 602, the element 608 has a first position and the second element 610 has first position. For this example, the two elements 608, 610 are graphical birds. In the second screen shot 604, the element 608 is in a second position. The second element 610, however, has been deleted from the environment in response to a detected event. In this case, the detected event is user input through a touch screen. The element 608 is in a third position in the third screen shot 606. The position of the elements 608, 610 and the motion paths through the environment are not based on any external events in this example. The existence of the elements 608, 610 however, is based on the occurrence of the communication event of receiving a voice mail. Accordingly, the element 610 has non-textual visual characteristics based a detected event, a communication event, and a generated event. Continuing with the example, the third element (vehicle) 612 represents an incoming call. In the second screen shot 604 the vehicle has a color (white) indicating that the call is currently being received. The non-textual visual characteristic of color indicates the state of an incoming call. In the third screen shot 606, the third element 612 has a color that is not white (indicated in FIG. 6 with cross hatched lines) to indicate that the call has been missed. Another color can be used to indicate that the call has been answered. Accordingly, each element in the environment may have any number of non-textual visual characteristics based on detected events, generated events, or communication events. The user interface manager 124 processes the data corresponding to the various events to generate a change the non-textual visual characteristics of the elements.

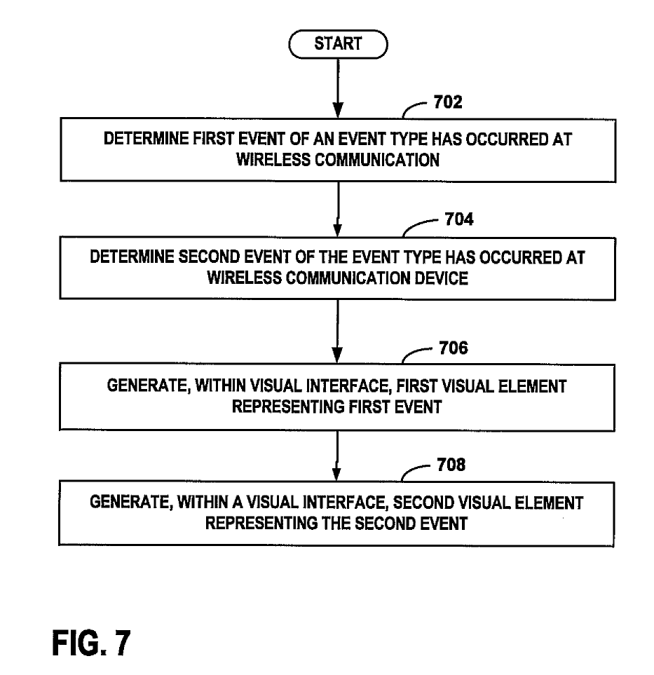

FIG. 7 is a flow chart of a method of user interface management for displaying different events at a wireless communication device. The method may be performed using any combination of hardware, firmware, or software. For the example of FIG. 7 the method is performed by the user interface manager 124 by running code on a processor of the controller 102 and generating control and data signals for controlling the visual interface 102. The steps discussed with reference to FIG. 7 may be executed in an order other than shown in FIG. 7 and two or more steps may be performed simultaneously in some circumstances.

At step 702, it is determined that a first event of a particular event type has occurred. The user interface manager 124 receives data from other sections of the controller 102 indicating that an event has occurred.

At step 704, it is determined that a second event has occurred that is of the same event type as the first event. The user interface manager 124 receives data from other sections of the controller 102 indicating that the second event has occurred. Examples of suitable event types include received email events, transmitted email events, voice mail events, missed call events, received text message events, sent text message events, dialed call events, received call events, received advertisements, alarms, and calendar reminders.

At step 706, a first visual element 116 is generated on the visual interface 102 to represent the first event 108. The user interface manager 124 applies information 112 of the first event to generate the first visual element 116 having a non-textual visual characteristic 120 representing the information 112.

At step 708, the second visual element 118 is generated on the visual interface. The user interface manager 124 applies second information 114 of the second event 110 to generate the second visual element representing the second event having a second non-textual visual characteristic 122 representing the second information 114. Accordingly, the first visual element 116 has a first non-textual visual characteristic 120 representing first information 112 related to the first event 108 and the second visual element 118 has a second non-textual visual characteristic 122 representing second information 114 related to the second event 110 where the first information 112 and the second information 114 are different. The visual interface 102, therefore, displays elements where each element looks different based on at least the information corresponding to the event that is represented. Examples of suitable information for the first information 112 and/or the second information 114 include a time received, a time sent, a time dialed, an alarm time, a battery charge, a remaining operation time, a calling party name, a calling party number, a called party number, a called party name, a sending party electronic mail (email) address, a receiving party email address, a message sending party name, a message sending party number, and a meeting type. Examples of the suitable non-textual visual characteristics 120, 122 include element size, element shape, element color, element position within the visual interface, element speed of motion within the visual interface, element path of motion within the visual interface, element direction of motion within the visual interface.

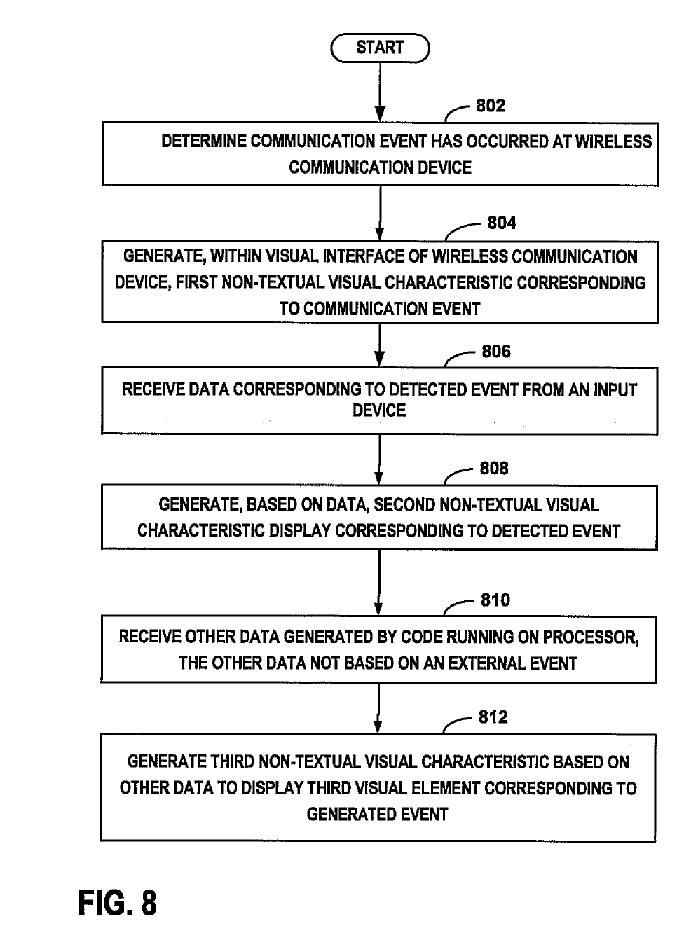

FIG. 8 is a flow chart of a method of user interface management for displaying communication events, detected events and generated events at a wireless communication device 300. The method may be performed using any combination of hardware, firmware, or software. For the example of FIG. 8, the method is performed by the user interface manager 124 by running code on a processor of the controller 102 and generating control and data signals for controlling the visual interface 302. The steps discussed with reference to FIG. 8 may be executed in an order other than shown in FIG. 8 and two or more steps may be performed simultaneously in some circumstances.

At step 802, it is determined that a communication event 320 has occurred. The user interface manager receives information from other functions within the controller or form other devices indicating that the communication event has occurred. Examples of communication events include received email events, transmitted email events, voice mail events, a missed call events, a received text message events, sent text message events, a dialed call events, received call events, and received advertisements.

At step 804, a visual element having a first non-textual visual characteristic 306 is generated on a visual interface where the characteristic corresponds to the communication event 320.

At step 806, data corresponding to a detected event 322 is received from an input device 326. As described above, the input device 326 may be a user input device or a sensor. The input device, therefore, detects external events such as environmental statistics and occurrences, orientations, positions and locations (and changes to the orientation, position, and location) of the wireless communication device.

At step 808, a visual element having a second non-textual visual characteristic 308 is generated where the characteristic 308 corresponds to the detected event 322. Examples of suitable non-textual visual characteristics include element size, element shape, element color, element position within the visual interface, element speed of motion within the visual interface, element path of motion within the visual interface, element direction of motion within the visual interface.

At step 810, data generated by code running on the processor is received. As discussed above, a generated event 324 is any event that occurs due to code 328 running on a processor that is not based on an external event such as communication event 320 or a detected event 322. The code 328 may be software or firmware and may be running on the same processor as the controller 106 or may be running on a separate computer, processor, controller, or other collection of electronics. Examples of generated events 324 include control signals for producing random or repetitive changes in an element or the visual interface environment. The changes may include changes in color, motion, size, position or any other visual characteristic that may appear random, cyclical or otherwise uncorrelated to external events.

At step 812, a third non-textual visual characteristic based on the generated data is generated to display the third visual element corresponding to the generated event 324.

Therefore, the method provides management of a visual interface 302 to simultaneously display an environment 304 having different non-textual visual characteristics representing communication events, detection events, and generated events. The user can determine the status of communications, wireless communication device functions and other occurrences by glancing at a single screen that also depicts an entertaining environment with generated elements that have changing visual characteristics not based on external events.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A wireless communication device comprising:
a visual interface comprising a first visual element representing a first event occurring at a wireless communication device and a second visual element representing a second event occurring at the wireless communication device and being of the same event type as the first event, the first visual element having a first non-textual visual characteristic representing first information related to the first event and the second visual element having a second non-textual visual characteristic representing second information related to the second event different from the first information, wherein the event type is one of a received email event, a transmitted email event, a voice mail event, a missed call event, a received text message event, a sent text message event, a dialed call event, a received call event, a received advertisement, an alarm, and a calendar reminder.

2. The wireless communication device of claim 1, wherein the first information is selected from the group comprising: a time received, a time sent, a time dialed, an alarm time, a battery charge, a remaining operation time, a calling party name, a calling party number, a called party number, a called party name, a sending party electronic mail (email) address, a receiving party email address, a message sending party name, a message sending party number, and a meeting type.

3. The wireless communication device of claim 1, wherein the first non-textual visual characteristic is selected from the group comprising: an element size, an element shape, an element color, an element position within the visual interface, an element speed of motion within the visual interface, an element path of motion within the visual interface, an element direction of motion within the visual interface.

4. The wireless communication device of claim 1, further comprising:
a user interface manager configured to provide control signals to the visual interface to generate the first element and the second element based on the first information and second information.

5. A wireless communication device comprising:
a visual interface comprising:
a first non-textual visual characteristic corresponding to a communication event;
a second non-textual visual characteristic display corresponding to a detected event; and
a third non-textual visual characteristic corresponding to a generated event.

6. The wireless communication device of claim 5, wherein the first non-textual visual characteristic is selected from the group comprising: an element size, and element shape, an element color, an element position within the visual interface, an element speed of motion within the visual interface, an element path of motion within the visual interface, an element direction of motion within the visual interface.

7. The wireless communication device of claim 5, wherein the communication event is one of a received email event, a transmitted email event, a voice mail event, a missed call event, a received text message event, a sent text message event, a dialed call event, a received call event, and a received advertisement.

8. The wireless communication device of claim 5, further comprising:
a user interface manager configured to generate the second non-textual visual characteristic based on data corresponding to the detected event and received from an input device.

9. The wireless communication device of claim 8, wherein the input device is a user interface and the data corresponds to a user input.

10. The wireless communication device of claim 8, the user interface manager further configured to generate the third non-textual visual characteristic based on other data generated by code running a processor, the other data not based on an external event.

11. The wireless communication device of claim 5, wherein two or more of the first, second, and third non-textual visual characteristics are characteristics of a single visual element within an environment displayed within the visual interface.

12. A method comprising:
determining a first event of an event type has occurred at a wireless communication;
determining a second event of the event type has occurred at the wireless communication device, the event type one of a received email event, a transmitted email event, a voice mail event, a missed call event, a received text message event, a sent text message event, a dialed call event, a received call event, a received advertisement, an alarm, and a calendar reminder;
generating, within a visual interface, a first visual element representing the first event; and
generating, within a visual interface, a second visual element representing the second event, the first visual element having a first non-textual visual characteristic representing first information related to the first event and the second visual element having a second non-textual visual characteristic representing second information related to the second event different from the first information.

13. The method of claim 12, wherein the first information is selected from the group comprising: a time received, a time sent, a time dialed, an alarm time, a battery charge, a remaining operation time, a calling party name, a calling party number, a called party number, a called party name, a sending party electronic mail (email) address, a receiving party email address, a message sending party name, a message sending party number, and a meeting type.

14. The method of claim 12, wherein the first non-textual visual characteristic is selected from the group comprising: an element size, an element shape, an element color, an element position within the visual interface, an element speed of motion within the visual interface, an element path of motion within the visual interface, an element direction of motion within the visual interface.

15. A method comprising:
generating, within a visual interface of a wireless communication device, a first non-textual visual characteristic corresponding to a communication event;
generating, within the visual interface, a second non-textual visual characteristic display corresponding to a detected event; and
generating, within the visual interface, a third non-textual visual characteristic corresponding to a generated event.

16. The method of claim 15, wherein the first non-textual visual characteristic is selected from the group comprising: an element size, an element shape, an element color, an element position within the visual interface, an element speed of motion within the visual interface, an element path of motion within the visual interface, an element direction of motion within the visual interface.

17. The method of claim 15, wherein the communication event is one of a received email event, a transmitted email event, a voice mail event, a missed call event, a received text message event, a sent text message event, a dialed call event, a received call event, and a received advertisement.

18. The method of claim 15, further comprising:
receiving data corresponding to the detected event from an input device;
generating the second non-textual visual characteristic based on the data.

19. The method of claim 18, wherein the input device is a user interface and the data corresponds to a user input.

20. The method of claim 18, further comprising:
generating the third non-textual visual characteristic based on other data generated by code running a processor, the other data not based on an external event.
